(19) United States
(12) Patent Application Publication
(10) Pub. No.: US 2025/0060025 A1
(43) Pub. Date: Feb. 20, 2025

(54) MECHANICAL DRIVE CONNECTION FOR DRIVING A SHAFT IN ROTATION BY TRANSMISSION UNDER TENSION

(71) Applicant: LATECOERE, Toulouse (FR)

(72) Inventor: Sébastien DEVILLEZ, SAINT JEAN (FR)

(73) Assignee: LATECOERE, Toulouse (FR)

(21) Appl. No.: 18/722,019

(22) PCT Filed: Dec. 7, 2022
(86) PCT No.: PCT/EP2022/084759

§ 371 Date: Jun. 20, 2024

(30) Foreign Application Priority Data
Dec. 21, 2021 (FR) FR2114144

(51) Int. Cl. F16H 19/00; F16G 9/00; F16H 55/36; F16H 55/50

(52) U.S. Cl. CPC F16H 19/005; F16G 9/00; F16H 55/50; F16H 2055/363

(57) ABSTRACT

A mechanical drive connection assembly (1) for driving in rotation a carrier shaft (2) of a structure rotating about a central axis (2a) passing through this carrier shaft (2). This connection (1) includes at least one drive ring (3a) that is secured to this carrier shaft (2) and driven in rotation in a given direction (S1) by a transmission member (4a, 4b). This transmission member is connected at one end to the drive ring (3a) by winding and at its other end to a traction device. The rotation in the opposite direction (S2) is generated by a second traction device (5) connected to the carrier shaft (2).

### CROSS REFERENCE TO RELATED APPLICATION

This application is a national stage entry of PCT/EP2022/084759 filed Dec. 7, 2022, under the International Convention and claiming priority over French Patent Application No. FR2114144 filed Dec. 21, 2021.

### TECHNICAL FIELD

The invention relates to a connection for mechanically driving a shaft in rotation, this rotational movement allowing a structure mounted on this shaft to pivot, in particular a panel such as a door. In particular, doors on vehicles—aircraft, trains, ships-and buildings are designed to rotate when opening and closing.

In aeronautics in particular, aircraft doors allow people and equipment to enter and leave the cabin. These doors, capable of maintaining the cabin in a pressurized state, also support a variety of equipment: they are generally heavy and require opening and closing assistance mechanisms to ensure correct positioning of the door by the drive handle. This mechanism generally consists of several shafts driven in rotation relative to each other.

### State of the Art

The principle of opening and closing a door is based on an engagement movement of the closing elements and a rotation of this door along an axis so as to release the opening. The engagement movement involves a link between a rotating handle and the mechanisms used to operate the door. This connection is made by linking several rotating shafts.

Traditionally, this mechanical shaft drive linkage is achieved by a system of connecting rods and levers, as illustrated in patent document U.S. Pat. No. 2,751,636. However, this solution generates limitations due to the kinematics of the connecting rod and lever linkage. In particular, it is impossible to drive a shaft in rotation through more than 150°. Furthermore, as the linkage with rods is used to open and close the door, these rods are subject to compressive stress, which defines the rod sizing criterion. As mechanical properties in compression are generally lower than in tension, the use of connecting rods does not allow the full mechanical capacities of the material used to make them to be exploited, resulting in oversizing and additional weight to be borne by the aircraft.

Other mechanical drive connections using pinions around a shaft, as well as chains, belts or racks, enable opening angles of over 150° to be achieved. However, pinions, chains and racks are expensive to produce. When using a toothed belt, tension is required to prevent it from slipping on the pinion teeth. However, these teeth cause the belt to shear, which is difficult to reinforce, particularly by adding fibers. Such a belt enables the shaft to make several turns around its axis, for example when driving a rotating system.

Drive pulley systems are also used to transmit rotation. In patents U.S. Pat. No. 4,903,536 A and JP S62 141349 A, a pulley system is used to precisely drive a robot arm. However, the system in U.S. Pat. No. 4,903,536 A incorporates a differential which reduces the rotation of the pulleys, thus slowing down the rotation transmitted. In addition, these systems are suitable for a precision robot arm operating small loads.

Patent JP S61 31756 A presents another precision pulley transmission system, with this rotary drive operating in both directions of rotation. The direction of rotation is selected by a clutch mechanism which selectively engages one direction of rotation. However, this system requires an additional clutch mechanism.

### SUMMARY OF THE INVENTION

In order to overcome the above-mentioned disadvantages of the state of the art, the main objective of the invention is to improve the rotational drive of a shaft, while avoiding slippage or friction between the shaft and the drive transmission elements, by means of a special connection capable of mechanically driving the shaft in rotation at high angles of rotation greater than 150°. To achieve this, a means of transmitting this mechanical connection is unwound from the shaft, working in tension.

More precisely, the object of the present invention is an assembly of a mechanical rotational drive link and a shaft carrying a structure which can rotate about a central axis of the shaft driven by said link. This connection comprises at least one traction means, a transmission member and a drive ring which is carried by the said shaft so as to rotate about the said central axis and translate along this axis.

Each drive ring is driven in rotation by the transmission member, which has a body and two ends. One of these ends, known as the driven end, is fitted to the drive ring and is wound around said ring. The other end, known as the driving end, is attached to the traction means, which unwinds the transmission member from the drive ring and rotates the support shaft in a given direction. Rotation in the opposite direction is generated by a second traction means connected to the support shaft.

This transmission member is only loaded in tension, which means that the transmission member's mechanical properties in tension are superior in strength to its mechanical properties in compression. The use of the transmission member is therefore mechanically more advantageous than the use of transmission rods.

The driven ring is driven in rotation by the transmission member without sliding or friction: advantageously, a smooth ring, easy to machine and of limited cost, can be used. This driven ring, fixed in rotation to the support shaft, transmits all rotational displacement to the support shaft.

According to a preferred design, the connection between the second traction means and the support shaft is achieved by a second transmission member, also having a body and two ends, fitted at one end, called the driven end, with a second drive ring also positioned on the support shaft. Its other end, referred to as the driving end, is fitted into the second traction means, enabling the second transmission member to be unwound from the support shaft and the support shaft to rotate in the opposite direction.

Advantageously, this second traction means driving rotation in the opposite direction to rotation of the support shaft combines its operation with that of the first traction means: the reverse rotation of the support shaft, caused by the unwinding of the second transmission member, simultaneously drives the winding of the first transmission member around its drive ring. Conversely, the unwinding of the first transmission member also simultaneously winds the second transmission member around its drive ring. In particular, this cooperation makes it possible to close and open a door attached to the support shaft in an aircraft.

In another preferred embodiment, each transmission member is looped on itself to form an elongated strap extending in a plane perpendicular to the central axis of rotation of the support shaft.

Advantageously, this bracelet provides double transmission of the shaft drive by doubling the body of the transmission member between each end via this loop. In addition, a bracelet transmission element provides double transmission in terms of tension, enabling the choice of materials for the transmission element to be extended to include materials whose lower strength is compensated for by this double transmission. In this way, an optimized and compatible choice of drive ring dimensions can be selected, in particular for rings in aircraft door mechanisms.

Advantageously too, the bracelet structure of the transmission member reduces the number of joints required. In fact, a simple transmission member has a junction at each of its ends, to reinforce the attachment zone for fixing. In contrast, a bracelet transmission element only has a joint in the area where the transmission element is attached to itself, which halves the number of joints required.

Another design combines the two previous preferred designs, namely the use of two rings for the two directions of rotation, each ring being associated with a transmission member. The transmission elements take the form of double-transmission bracelets arranged opposite each other, but offset along the support shaft.

According to preferred embodiments taken separately or in combination:
each strap transmission member is made of a flexible material;
each strap transmission member is of a type selected from a cable and a belt;
the cable can be looped over itself with a splice and the belt with a seam;
each drive ring is equipped with a fastener for securing the driven end of the transmission member, this fastener comprising at least one fixing bar which, when the transmission member is a cable, holds this transmission member directly on the drive ring and which, when the transmission member is a belt, holds a pin around which the belt is wound;
each traction means is a traction shaft rotating about an axis of rotation parallel to the central axis of rotation, and comprising a drive wheel which winds up the corresponding transmission member;
each drive wheel, ring and corresponding transmission member form a group extending in a plane perpendicular to the central axis of the support shaft;
the drive rings can be united and form a single part;
the traction shaft is common to the traction means and one of the drive wheels is fixed to this traction shaft, the other drive wheel being fixed to the first by a tension mechanism achieving an angular adjustment between these drive wheels;
the drive wheel has a radius greater than the radius of the drive ring and forms an angular sector defined by an angle dependent on the radius of the drive ring, the radius of the drive wheel and a predefined maximum angle of rotation;
each drive wheel is equipped with a means of engagement for winding the drive end of the transmission member comprising a tension terminal of adjustable diameter, extending in a plane perpendicular to the central axis of the support shaft when the transmission member is a cable, and extending parallel to the central axis of rotation when the transmission member is a belt;
the gripping means of the drive wheel is positioned along a radial side of the angular sector and the drive end of the transmission member is bent along this radial side;
the maximum predefined angle of rotation of the support shaft is 300 degrees;
the common drive shaft is equipped with an activation command that drives its rotation and that of the drive wheel;

The bracelet transmission components are made of a material selected from composites and metals, and

The drive rings and drive wheels are made of metal.

It may be pointed out that the upper radius of the drive wheel drives the rotation of the support shaft according to an upper lever arm, which advantageously facilitates its rotation, in particular when a heavy element—such as an aircraft door—is moved.

Advantageously too, the combination of at least two pairs of drive rings and drive wheels enables the carrier shaft to be rotated in both directions along its axis, each of these rotations taking place under tension.

According to at least one of the above uses, the support shaft structure is an aircraft cabin door.

According to a process for producing a transmission member from a mechanical bonding strap in accordance with the invention, this composite material transmission member is produced by winding layers of fibers held between two stops, followed by draping impregnation of the fibers with a hyperelastic resin. This process eliminates the majority of the cutting load generated by the production of a transmission element from a cut linear product.

Preferably, the fiber used is carbon fiber, to improve the stiffness of the force transmission. Advantageously, a sheath of hyper-elastic material can cover the transmission member to protect the fiber, to ensure the loading of the fiber ends and to guarantee the cohesion of the product.

The invention also relates to a method of installing the mechanical drive linkage assembly for rotating a support shaft defined above. Installation involves the following steps:
positioning at least one drive ring and at least one drive wheel opposite each other on the support shaft and traction shaft respectively;
locking the drive rings and a drive wheel on the support shaft and traction shaft respectively.
joining of a strap transmission member at a length adjusted to the linkage assembly for each drive ring positioned;
selecting the diameter of the terminals at the ends of the transmission members and fitting and tensioning each transmission member on these terminals and pins.

According to preferred forms of implementation:-two linkage assemblies are installed in staggered arrangement on the support shaft and the traction shaft, providing a rotary drive for the support shaft in both directions;
the tensioning of the transmission members is performed by the tensioning mechanism connecting the driving wheels of these two linkage assemblies;
a step to verify the installation and tensioning of the transmission members, and

After the verification step, a step, if necessary, to adjust the tensioning of the transmission members by installing terminals of different diameters.

### BRIEF DESCRIPTION OF THE DRAWINGS

Further features and advantages of the present invention will become apparent from the following detailed embodiment, without limiting the scope thereof, with reference to the appended figures, which show, respectively:

FIG. 1, a perspective view of the mechanical belt drive connection of a shaft;

FIG. 2 shows a side view of this belt drive connection;

FIG. 3a shows a top sectional view of the belt drive linkage at different drive times;

FIG. 3b shows another top sectional view of the belt drive linkage at different drive times;

FIG. 4, bottom view of the belt drive link;

FIG. 5, a perspective view of the mechanical shaft cable drive connection;

FIG. 6, a top view of the cable drive link;

FIG. 7, a perspective view of the drive shaft, in particular with drive wheels;

FIG. 8a shows a perspective view of the cable fastening clip on the drive ring without the cable fastening clip;

FIG. 8b shows a perspective view of the cable fastening clip on the drive ring with the cable fastening clip;

FIG. 9, a schematic view of a fiber winding for a composite transmission member, and

FIG. 10 shows a process flow diagram for installing the mechanical rotary drive linkage.

### DETAILED DESCRIPTION OF THE INVENTION

In the figures, identical reference signs refer to the same element and to the corresponding passages in the description.

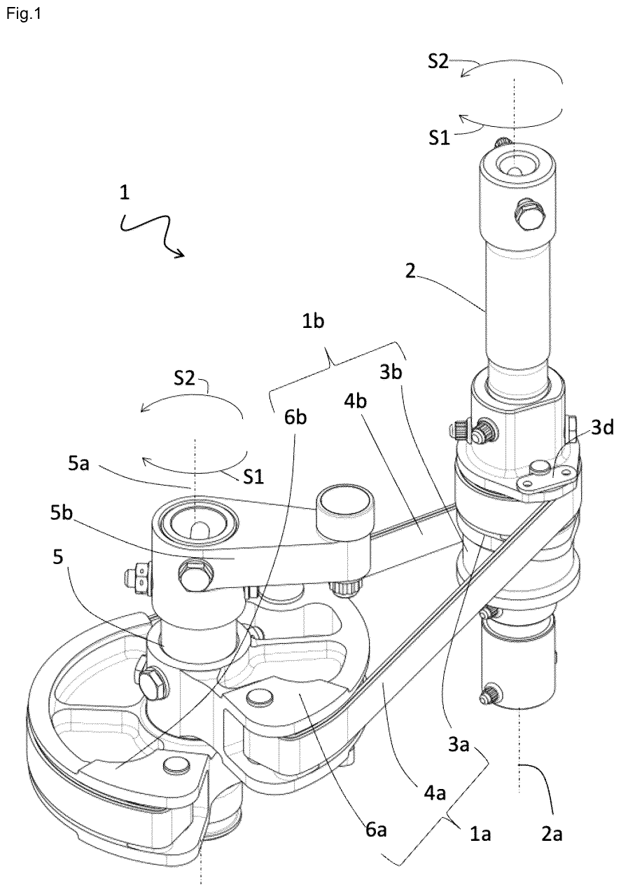

FIG. 1 shows a linkage assembly (1) for mechanically driving the bearing shaft (2) of an aircraft door (not shown) in rotation about the central axis (2a) of the bearing shaft (2) driven by said linkage, which comprises two traction means, two transmission members and two drive rings (3a, 3b) carried by the bearing shaft (2) in rotation about the central axis (2a) and in translation along this axis. Each drive ring 3a, 3b is driven in rotation by a belt-type transmission member 4a, 4b, looped on itself, and fitted at its driving end into the traction means. In this example, the traction means comprise a traction shaft 5 and two drive wheels 6a, 6b. Traction shaft 5 is common to both belts 4a, 4b and rotates about its axis 5a parallel to the central axis 2a of rotation. The two drive wheels 6a, 6b, fixed to the drive shaft 5, wind up the corresponding belt 4a, 4b.

Each drive wheel 6a, 6b, drive ring 3a, 3b and corresponding belt 4a, 4b form a grouping 1a, 1b extending in a plane perpendicular to the central axis 2a of the support shaft 2 and enabling rotation of the support shaft 2 in either of two opposite directions of rotation: a given direction S1 (clockwise in the plane of the linking groupings 1a, 1b) and the opposite direction S2 (anticlockwise).

In this embodiment, the common drive shaft 5 has an activation drive 5b, in the illustrated example a connecting rod coupled to a rotary drive system (not shown), which drives the rotation of the drive shaft 5 and that of the drive wheels 6a, 6b. This activation command 5b thus enables the traction shaft 5 to rotate in either direction S1 or S2, and thus causes the carrier shaft 2 to rotate in the same direction, by pulling one or other of the belts 4a, 4b, which is wound around the corresponding drive wheel 6a, 6b. This pull then simultaneously causes the corresponding belt 4a, 4b to unwind around the drive shaft 2. Depending on the application, a maximum angle of rotation of the support shaft 2 is predefined: this can be large, thanks to the tensile winding drives. In this example, the maximum angle of rotation is 300 degrees.

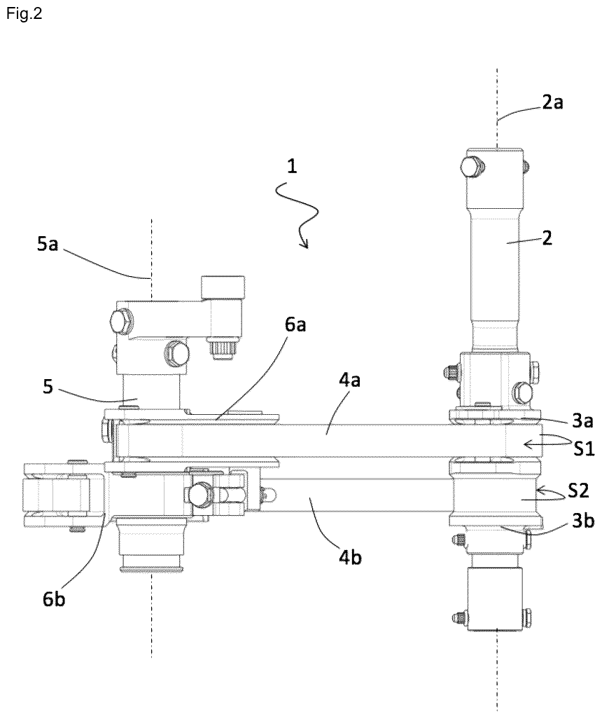

FIG. 2 shows a side view of linkage 1, which drives the support shaft 2 in rotation via the two belts 4a, 4b, which transmit the rotation of traction shaft 5 to support shaft 2, each belt transmitting one of the directions of rotation, clockwise S1 for belt 4a and anti-clockwise S2 for belt 4b. The drive rings 3a, 3b and drive wheels 6a, 6b are positioned one above the other along the support shaft 2 and traction shaft 5 respectively. In this embodiment, the drive rings 3a, 3b are united and form a single part: they can also be independent and attached individually to the support shaft 2.

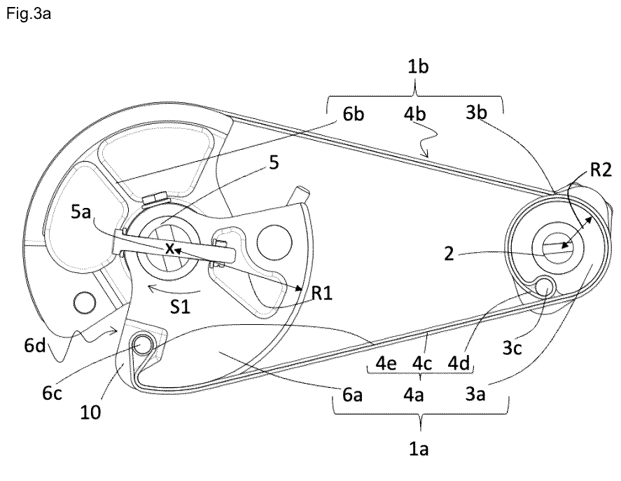

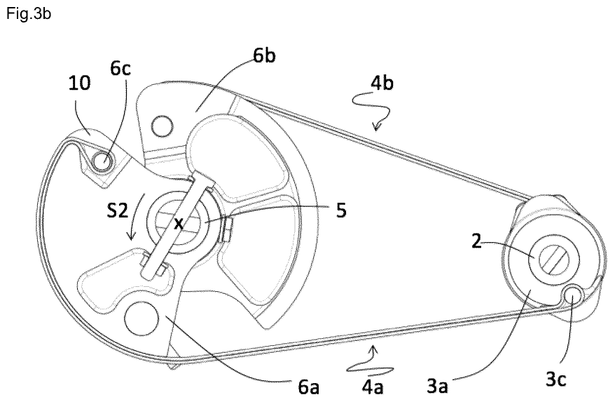

The top views in FIG. 3a and FIG. 3b illustrate the linkage groups 1a, 1b at the start and end, respectively, of rotation of the support shaft 2 by the belts 4a, 4b. One of the drive elements, in this case belt 4a, has a body 4c and two ends. One of these ends, called the driven end 4d, is fitted to the drive ring 3a, and is wound around said ring. The other end, called the driving end 4e, is fitted into the traction means driving the unwinding of the belt 4a on the drive ring 3a and the rotation of the carrier shaft 2 in a given direction, clockwise S1.

The counter-clockwise rotation S2 is generated by the drive shaft 5, which is connected to the support shaft 2 via the belt 4b. The belt also has a body 4c and two ends, one end 4d, called the driven end, being attached to the second drive ring 3b, also positioned on the support shaft 2. Its other end 4e, known as the driving end, is attached to the traction shaft 5 and drives the unwinding of belt 4b and the reverse rotation S2 of the support shaft 2.

In this example, traction shaft 5 serves as a common traction means for both belts 4a, 4b. More generally, a second traction means distinct from shaft 5 can be provided for belt 4b, in the form of another shaft parallel to shaft 5 or any mechanical member with an equivalent function (cardan joint, drive train, etc.).

FIG. 3a shows that a transmission member according to the invention, for example the belt 4a of group 1a, is advantageously looped on itself, here at its ends 4d, 4e to form an elongated bracelet extending in a plane perpendicular to the central axis 2a of rotation of the carrier shaft 2 and made of a flexible material, preferably metal or composite. The drive ring 3a is equipped with a fastener for securing the driven end 4d of the transmission member. This fastener comprises a fastening bar 3d (see FIG. 1) which holds a pin 3c around which the driven end 4d of the belt 4a is wound.

The drive wheel 6a is equipped with an engagement means for winding the drive end 4e of the belt 4a. The engagement means comprises, in this example, a tensioning terminal 6c of adjustable diameter extending parallel to the central axis 2a of rotation. The diameter can be adjusted by using another terminal 6c with a different diameter: a larger (respectively smaller) terminal diameter increases (respectively decreases) its circumference and the length of belt 4a, 4b running around it, thus enabling adjustment of the cable installation. Other gripping means, such as a clamp or groove, can be used to wind the drive end of the transmission members. Alternatively, a system for adjusting the position of the terminal on a slide can be used, or any other equivalent means (push system, etc.).

Like grouping 1a, the elements of grouping 1b have identical features: the belt 4b is also looped at its ends around a pin (not shown) similar to pin 3c held by a bar (not shown) similar to bar 3d on drive ring 3b and a terminal (not shown) corresponding to terminal 6c of drive wheel 6b.

In FIG. 3a, the belt 4a is wound around the drive ring 3a: under the action of the activation command 5b (see FIG. 1), the drive wheel 6a rotates around its axis 5a in direction S1, and drives the belt 4a under tension to reach the configuration shown in FIG. 3b. The rotation of drive ring 3a is illustrated by the rotation of pin 3c, of the order of 300 degrees in this example.

The drive wheel 6a has a radius R1 greater than the radius R2 of the drive ring 3a and forms an angular sector defined by an angle dependent on the radius R2, the radius R1 and a predefined maximum angle of rotation, here equal to 300 degrees. In other embodiments, the radius R1 of the drive wheel 6a may be smaller than the radius R2 of the drive wheel 3a.

The gripping means of the drive wheel 6a is positioned along a radial side 6d of this angular sector by the position of the terminal 6c integrated in a cavity 10 of the wheel 6a, and the drive end 4e of the belt 4a is then folded along this side 6d. To optimize the mass of the connection, the length of belt 4a unwound over the 300 degrees of the drive ring 3a corresponds to the length of belt 4a wound on the driving wheel 6a and therefore to the dimensions of the angular sector of this driving wheel 6a. To optimize the balance of the drive wheel 6a, the latter can be complete or reduced to any sector of intermediate size suited to this balance.

The drive wheels 6a and 6b are fitted to the drive shaft 5 in translation along the shaft axis, and rotate about their common axis 5a, which coincides with the drive shaft 5 axis: rotation of one of the wheels 6a, 6b results in rotation of the other in the same direction. Thus, the winding of one of the belts 4a, 4b around the drive wheel 6a, 6b corresponds to its unwinding by traction around the associated drive ring 3a, 3b. This unwinding then corresponds to the winding of the other belt 4b, 4a around the other ring 3b, 3a, as well as the unwinding of this other belt 4b, 4a around the corresponding wheel 6b, 6a to achieve the configuration shown in FIG. 3b. The two linkage assemblies 1a and 1b operate in opposition, depending on the direction of rotation S1 or S2 initially generated by drive 5b, and cause the carrier shaft 2 to rotate in opposite directions, S1 and S2 respectively.

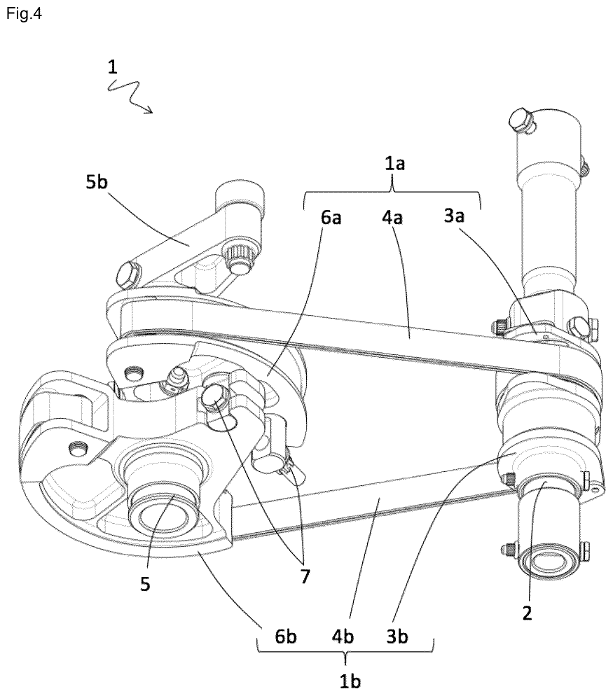

FIG. 4 shows a view of the underside of linkage 1, which mechanically drives the support shaft 2 in rotation. The two linkage assemblies 1a and 1b are visible, in particular the drive wheels 6a and 6b of the traction shaft 5. Only the drive wheel 6a is fixed to the shaft 5 and rotationally rigid with it, while the other drive wheel 6b is fixed to the drive wheel 6a by a tensioning mechanism 7. This mechanism produces an angular adjustment between these driving wheels and enables the driving wheel 6b to be driven by the driving wheel 6a, the driving wheel 6b being free to rotate relative to the traction shaft 5. This tensioning mechanism 7, consisting of a screw-nut system in the example, generates tension between the driving wheels 6a and 6b via the two clusters 1a and 1b. The two drive rings 3a and 3b are also visible, each associated with a belt 4a, 4b looped on itself by a seam and making a double-transmission bracelet, these belts being arranged opposite each other while being offset along the carrier shaft 2.

Alternatively, the drive wheel 6b can be fixed to the traction axle 5 so that it also rotates with it, in which case angular adjustment between the drive wheels is achieved without a tensioning mechanism 7.

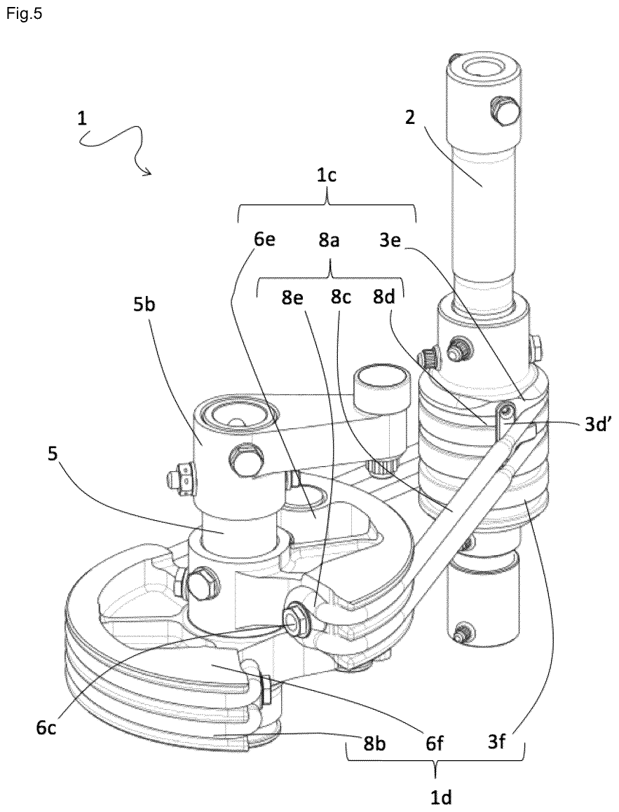

A further example of the use of cable-type transmission elements is shown in FIG. 5. These cables 8a and 8b, which are also looped back on themselves by a splice, have a body 8c and ends—a driven end 8d and a driving end 8e—which are connected to drive rings 3e, 3f and drive wheels 6e, 6f to form groups 1c and 1d. The operation of these groups 1c and 1d is similar to that of groups 1a and 1b described above. The structural variations between these groupings, due to a different type of transmission member, concern the fasteners on the drive rings 3e, 3f and the means of engagement on the drive wheels 6e, 6f of the cables 8a and 8b.

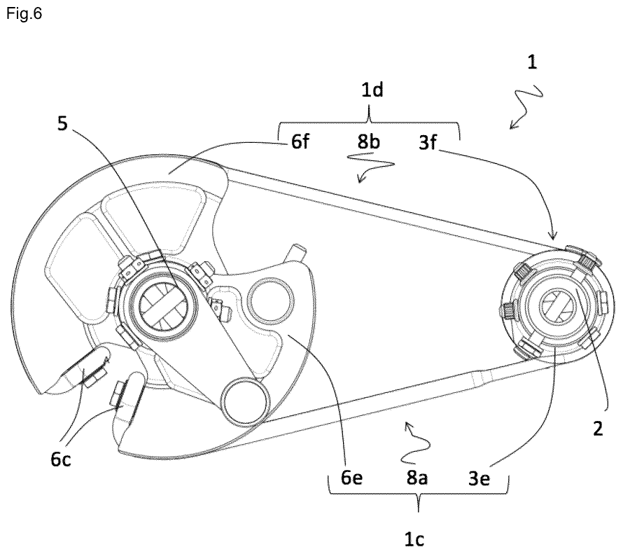

The top view in FIG. 6 shows linkage 1, which mechanically drives the support shaft 2 in rotation via cable-type transmission elements. This support shaft 2 and the traction shaft 5 are connected by the two assemblies 1c, 1d enabling the support shaft 2 to rotate in both directions. In particular, the means for engaging the drive wheels 6e, 6f to wind up the drive end of the cables 8a, 8b comprises a terminal 6c of adjustable diameter extending in the plane perpendicular to the central axis of the support shaft. To make the diameter adjustable, and similarly to what is described above for belts, another terminal 6c of different diameter can be used in the gripping means: a larger terminal diameter increases its circumference and the length of cable 8a, 8b running around it, thus adding tension to the cable. Conversely, using a smaller-diameter terminal 6c reduces cable tension if the cable was too short and therefore too taut. Alternatively, means of adjusting the terminal position can be provided.

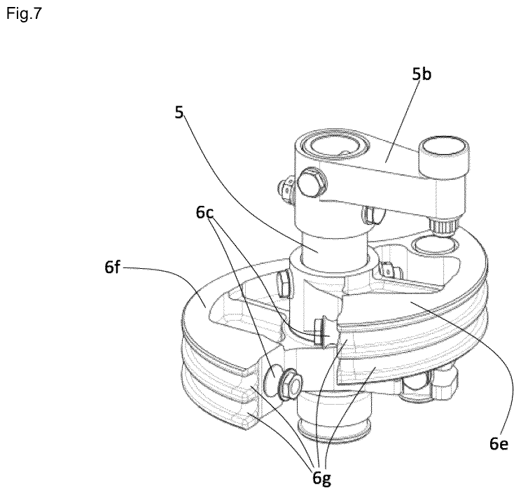

With reference to FIG. 7, the traction means of the rotary drive linkage 1 are shown without the cables. Traction shaft 5 is connected to activation drive 5b on the one hand, and to drive wheels 6e, 6f on the other. These drive wheels 6e, 6f wind and unwind the drive end of the cables 8a, 8b around their circumference: in this example, optional grooves 6g have been machined to facilitate precise cable winding.

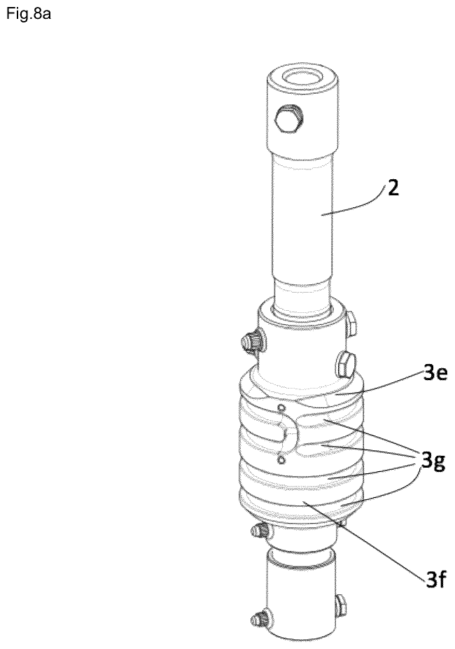

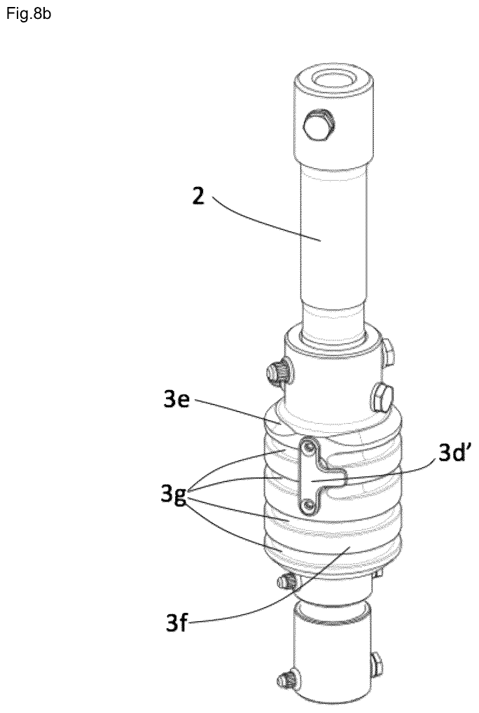

FIG. 8a and FIG. 8b show the support shaft 2 with the drive rings 3e, 3f of the mechanical rotary drive linkage 1, either without cables or with a cable clamp (FIG. 8a) or with a cable clamp (FIG. 8b). In the embodiment shown, grooves 3g are machined into the drive rings 3e, 3f, these grooves 3g accommodating the cables 8a, 8b: in particular, the grooves follow the cable loop formed at the driven cable ends 8d (see FIG. 5). The drive rings 3e, 3f are equipped with a fastener comprising a fastening bar 3d′ and known fastening means of such a bar for directly securing the driven end of the cable.

In a further embodiment, a pin similar to the dowel 3c—previously used for belts 3a, 3b (see FIGS. 3a, 3b)—can be used in combination with the fastening bar 3d′ to form the looped attachment of the cable 8a, 8b. The attachment of the cable drive rings 3e, 3f then becomes similar to the attachment of the belt drive rings 3a, 3b, with the pins fixed radially (to loop the cables 8a, 8b) or parallel (to tension the belts 3a, 3b) to the support shaft 2.

Advantageously, the grooves 6g and furrows 3g retain the smooth appearance of the driving wheels and corresponding drive rings.

In some embodiments, belts and cables can be made from a linear product that is cut, looped and joined together at its ends to form a bracelet. Alternatively, this strap can be looped directly around the drive wheel and drive ring fasteners. The connection is made by hooking the ends of the linear product together by splicing for a cable and sewing for a belt, or by attaching these ends to the drive wheels and drive rings.

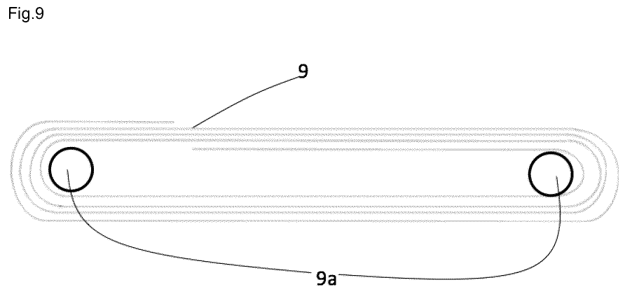

In a further embodiment illustrated in FIG. 9, the strap transmission member is made of composite material and manufactured directly to the correct dimensions in the following steps:
winding of fibre layers 9b held between two stops 9a, then
draping impregnation of fibers 9b with a hyperelastic resin.

In a preferred embodiment, the fiber used is carbon fiber, which has a good mechanical strength content.

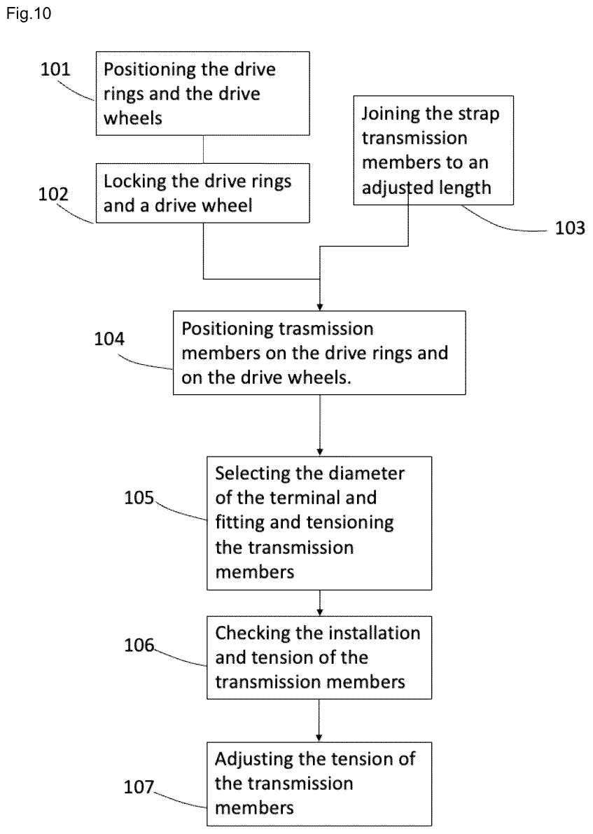

The flow chart shown in FIG. 10 details the steps involved in an example of a process for installing the linkage 1 for mechanically driving a support shaft in rotation, according to a preferred implementation:
a step 101 for positioning two drive rings 3a, 3b and two drive wheels 6a, 6b opposite each other on the support shaft 2 and traction shaft 5 respectively;
a step 102 for locking the drive rings 3a, 3b and a drive wheel 6a on the support shaft 2 and traction shaft 5 respectively;
a step 103 for joining the strap transmission members, belts 4a, 4b or cables 8a, 8b, to a length adjusted to the connection group 1a, 1b or 1c, 1d for each positioned drive ring 3a, 3b or 3e, 3f;
a step 104 for positioning each transmission member on the drive ring 3a, 3b or 3e, 3f and on the corresponding drive wheel 6a, 6b or 6e, 6f;
a step 105 for selecting the diameter of the terminals 6c (see FIGS. 3a and 6) at the end of the transmission members and for fitting and tensioning each transmission member on these terminals and the pins, and if necessary
a step 106 to check the installation and tension of the transmission members, and
a step 107 for adjusting the tension of the transmission members by installing terminals 6c of different diameters.

In this implementation, two assemblies 1a, 1b, installed offset on the support shaft 2 and traction shaft 5 (see FIG. 1), rotate the support shaft 2 in both directions. Tensioning of the drive elements is performed by the tensioning mechanism 7 connecting the drive wheels 6a, 6b or 6e, 5f of these two linkage assemblies (see FIG. 4).

The invention is not limited to the examples described and illustrated. For example, traction means other than a shaft with a drive wheel can be used, such as a translation drive which can be motorized, or a cylinder to which the transmission member is attached.

A return means can also be used to rotate the drive shaft in the opposite direction. This return means, such as a helical spring or elastic leaf, is capable of returning the support shaft to its initial position after activation.

Furthermore, when using the present invention to operate an aircraft door, the drive rings and drive wheels are smooth and made of a preferably metallic material. Depending on availability, non-smooth elements can also be used. Ceramic, plastic and composite rings and wheels can also be used for other rotary motion applications.

The invention can also be combined with itself to multiply the number of groups, as the examples described above use only one group per given direction of rotation and the same type of transmission member-belt or cable. In fact, using two or more groupings to transmit a given direction of rotation reduces the tensile force on all the parts in the grouping, and also provides an emergency transmission in the event of one of them breaking. In addition, different types of transmission elements can be used for each grouping.

1. An assembly of a mechanical drive connection (1) for rotating a support shaft (2) of a structure which rotates about a central axis (2a) of the support shaft (2) driven by said connection (1), the assembly comprising:
at least one traction;
a transmission member, and
a drive ring (3a, 3e) carried by said support shaft (2) for rotation about said central axis (2a) and for translation along said axis:
wherein the drive ring (3a, 3e) is driven in rotation by the transmission member (4a, 4b; 8a, 8b) having a body (4c; 8c) and a first we ends, one of which, the driven end (4d; 8d) is fitted to the drive ring (3a, 3e) and wound around said ring, and the a second end (4e; 8e) fitted into the traction device causing the transmission member to unwind from the drive ring (3a, 3e) and the carrier shaft (2) to rotate in a given direction (S1), a rotation in the opposite direction (S2) being generated by a second traction device connected to the carrier shaft (2) and in that each one of the traction device is a traction shaft (5) rotating about an axis (5a) of rotation parallel to the central axis (2a) of rotation and comprising a drive wheel (6a, 6b, 6e, 6f) which winds up the corresponding transmission member.

2. The assembly according to claim 1, wherein the connection between the second traction device and the support shaft (2) is made by a second transmission member also having a body and two ends, fitted at one end called the driven end to a second drive ring (3b, 3f) also positioned on the support shaft (2), its other end called the driving end being fitted into the second traction device.

3. The assembly according to claim 2, wherein the drive rings (3a, 3b; 3e, 3f) are united and form a single part.

4. The assembly according to claim 2, . wherein each transmission member is looped on itself to form an elongate bracelet extending in a plane perpendicular to the central axis (2a) of rotation of the support shaft (2).

5. The assembly according to claim 4, wherein each bracelet transmission member is made of a flexible material.

6. The assembly according to claim 4, wherein each strap transmission member is of a type selected from a cable (8a, 8b) and a belt (4a, 4b).

7. The assembly according to claim 6, wherein the cable (8a, 8b) is looped on itself by a splice and the belt (4a, 4b) by a seam.

8. The assembly according to claim 2, wherein each drive ring (3a, 3b; 3e, 3f) is equipped with a fastener for securing the driven end of the transmission member, this fastener comprising at least one fixing bar (3d) which, when the transmission member is a cable (8a, 8b), holds this transmission member directly to the drive ring (3e, 3f) and, when the transmission member is a belt (4a, 4b), holds a pin (3c) around which the belt (4a, 4b) is wound.

9. The assembly according to claim 1, wherein each drive wheel (6a, 6b, 6e, 6f), drive ring (3a, 3b, 3e, 3f) and corresponding transmission member form a connecting group (1a, 1b, 1c, 1d) extending in a plane perpendicular to the central axis of the support shaft (2).

10. The assembly according to claim 1, wherein the traction shaft (5) is common to the traction device and one of the drive wheels (6a, 6e) is fixed to this traction shaft (5), the other drive wheel (6b, 6f) being fixed to this drive wheel (6a, 6e) by a tensioning mechanism (7) achieving an angular adjustment between these drive wheels.

11. The assembly according to claim 1, wherein the drive wheels (6a, 6b, 6e, 6f) have a radius (R1) greater than that (R2) of the drive rings (3a, 3b, 3e, 3f) and form an angular sector defined by an angle dependent on the radius (R2) of the drive rings (3a, 3b, 3e, 3f), the radius (R1) of the drive wheels (6a, 6b, 6e, 6f) and a predefined maximum angle of rotation of the support shaft (2).

12. The assembly according to claim 1, wherein each drive wheel (6a, 6b, 6e, 6f) is equipped with an engagement for winding the drive end of the transmission member comprising a tension terminal (6c) extending in a plane perpendicular to the central axis (2a) of the support shaft (2) when the transmission member is a cable (8a, 8b) and extending parallel to the central axis (2a) of rotation when the transmission member is a belt (4a, 4b).

13. The assembly according to claim 12, wherein the engagement device of each drive wheel (6a, 6b, 6e, 6f) is positioned along a radial side (6d) of the angular sector and the drive end of the transmission member is folded along this radial side (6d).

14. The assembly according to claim 1, wherein the predefined maximum angle of rotation of the support shaft (2) is 300 degrees.

15. The assembly according to claim 11 wherein the common traction shaft (5) has an activation drive (5b) which drives its rotation and that of each drive wheel (6a, 6b, 6e, 6f).

16. The assembly according to claim 4 wherein the bracelet transmission members are made of a material chosen from composites and metals.

17. The assembly according to claim 1, wherein the drive rings (3a, 3b, 3e, 3f) and the drive wheels (6a, 6b, 6e, 6f) are made of metal.

18. A method of producing a transmission member in the form of a mechanical connection strap made of composite material according to claim 1, wherein the transmission member is produced by winding layers of fibers held between two stops and then impregnating the fiber drape with a hyperelastic resin.

19. A method of installing the mechanical rotary drive linkage assembly (1) and a carrier shaft (2) according to claim 1, the method comprising the following steps:
positioning at least one drive ring (3a, 3b, 3e, 3f) and at least one drive wheel (6a, 6b, 6e, 6f) opposite each other on the support shaft (2) and traction shaft (5) respectively, traction shaft (5) rotating about the axis (5a) of rotation parallel to the central axis (2a) of rotation of the support shaft (2);
locking the drive rings (3a, 3b, 3e, 3f) and a drive wheel (6a, 6e) on the support shaft (2) and traction shaft (5) respectively;
joining of a strap transmission member at a length adjusted to the connecting assembly (1a, 1b, 1c, 1f) for each drive ring (3a, 3b, 3e, 3f) positioned;
positioning of each transmission member on the corresponding drive ring (3a, 3b, 3e, 3f) and drive wheel (6a, 6b, 6e, 6f), and
selecting the diameter of the tensioning terminals (6c) at the end of the transmission members and positioning and tensioning of each transmission member on these terminals (6c) and the pins (3c).

20. The method of installing the drive linkage assembly (1) according to claim 19, wherein the drive rings (3a, 3b, 3e, 3f) of two linkage assemblies (1a, 1b; 1c, 1d) are installed offset on the carrier shaft (2).

21. The method of installing the drive linkage assembly (1) according to claim 20, wherein the tensioning of the transmission members is performed by the tensioning mechanism (7) connecting the drive wheels (6a, 6b, 6e, 6f) of these two linkage assemblies (1a, 1b; 1c, 1d).

22. The method of installing the drive link assembly (1) according to claim 19, wherein the method comprises a step of checking the installation and tensioning of the transmission members.

23. The method of installing the drive link assembly (1) according to claims 20, further comprising the step of adjusting the tension of the transmission members by installing terminals (6c) of different diameters.
